(19) United States
(12) Patent Application Publication
(10) Pub. No.: US 2025/0307999 A1
(43) Pub. Date: Oct. 2, 2025

(54) DATA PROCESSING METHOD, IMAGE FORMING METHOD, ELECTRONIC DEVICE, IMAGE FORMING DEVICE, AND STORAGE MEDIUM

(71) Applicant: Zhuhai Pantum Electronics Co., Ltd., Zhuhai (CN)

(72) Inventors: Yangxiao MA, Zhuhai (CN); Fujin HUANG, Zhuhai (CN)

(21) Appl. No.: 19/078,024

(22) Filed: Mar. 12, 2025

(30) Foreign Application Priority Data
Mar. 26, 2024 (CN) 202410355067.0

(51) Int. Cl. G06T 5/70; G06T 7/13; H04N 1/405; H04N 5/74

(52) U.S. Cl. CPC G06T 5/70; G06T 7/13; H04N 1/405; H04N 5/74

(57) ABSTRACT

A data processing method, an image forming method, an electronic device, an image forming device, and a storage medium are provided. The data processing method includes: obtaining image data to be processed, where the image data to be processed is halftone image data; performing edge detection on the image data to be processed to determine edge pixels in the image data to be processed; and smoothing the edge pixels to obtain processed image data.

### CROSS-REFERENCE TO RELATED APPLICATION

This application claims the priority of Chinese Patent Application No. 202410355067.0, filed on Mar. 26, 2024, the content of which is incorporated herein by reference in its entirety.

### TECHNICAL FIELD

The present disclosure generally relates to the field of data processing technologies and, more particularly, relates to a data processing method, an image forming method, an electronic device, an image forming device, and a storage medium.

### BACKGROUND

An image forming device is a device that forms an image on a recording medium through the principle of imaging, such as a printer, a copier, a fax machine, a multifunctional image forming and copying device, an electrostatic printing device, or any other similar device.

Before performing an image forming operation, the image forming device usually needs to perform halftone processing on original image data (e.g., 8-bit image data) to convert the original image data into halftone image data, and then perform the image forming operation based on the halftone image data. However, the halftone processing will brighten edge pixels in the image, thereby generating aliasing edges and affecting the user experience.

It should be pointed out that the information disclosed in the background technology section of the present disclosure is only intended to deepen the understanding of the general background technology of the present disclosure, and should not be regarded as an admission or in any form of implication that the information constitutes prior art known to those skilled in the art.

### SUMMARY

One aspect of the present disclosure provides a data processing method. The method includes: obtaining image data to be processed, where the image data to be processed is halftone image data; performing edge detection on the image data to be processed to determine edge pixels in the image data to be processed; and smoothing the edge pixels to obtain processed image data.

Another aspect of the present disclosure provides an image forming method. The method includes: in response to a first mode triggered by a user, performing an image forming operation on image data to be processed; or, in response to a second mode triggered by a user, processing the image data to be processed to obtain processed image data and performing an image forming operation on the processed image data. Processing the image data to be processed to obtain the processed image data includes: obtaining the image data to be processed, where the image data to be processed is halftone image data; performing edge detection on the image data to be processed to determine edge pixels in the image data to be processed; and smoothing the edge pixels to obtain the processed image data.

Another aspect of the present disclosure provides a non-transitory computer-readable storage medium. The non-transitory computer-readable storage medium is configured to store a program; and, when the program is running, a device where the computer-readable storage medium is located is configured to perform: obtaining image data to be processed, where the image data to be processed is halftone image data; performing edge detection on the image data to be processed to determine edge pixels in the image data to be processed; and smoothing the edge pixels to obtain processed image data.

### BRIEF DESCRIPTION OF THE DRAWINGS

The following drawings are merely examples for illustrative purposes according to various disclosed embodiments and are not intended to limit the scope of the present disclosure.

FIG. 1 illustrates an image forming device according to various disclosed embodiments of the present disclosure.

FIG. 2A illustrates a schematic diagram of an image before anti-aliasing processing according to various disclosed embodiments of the present disclosure.

FIG. 2B illustrates a schematic diagram of an image after anti-aliasing processing on an original image according to various disclosed embodiments of the present disclosure.

FIG. 2C illustrates a schematic diagram of an image after anti-aliasing processing on a halftone image according to various disclosed embodiments of the present disclosure.

FIG. 3A illustrates another schematic diagram of an image before anti-aliasing processing according to various disclosed embodiments of the present disclosure.

FIG. 3B illustrates another schematic diagram of an image after anti-aliasing processing on an original image according to various disclosed embodiments of the present disclosure.

FIG. 3C illustrates another schematic diagram of an image after anti-aliasing processing on a halftone image according to various disclosed embodiments of the present disclosure.

FIG. 4 illustrates an exemplary data processing method according to various disclosed embodiments of the present disclosure.

FIG. 5A illustrates an image to be processed according to various disclosed embodiments of the present disclosure.

FIG. 5B illustrates another image to be processed according to various disclosed embodiments of the present disclosure.

FIG. 5C illustrates a projection area according to various disclosed embodiments of the present disclosure.

FIG. 5D illustrates a projection area after filling according to various disclosed embodiments of the present disclosure.

FIG. 5E illustrates an image after filling according to various disclosed embodiments of the present disclosure.

FIG. 5F illustrates a schematic diagram of an edge pixel recognition scenario according to various disclosed embodiments of the present disclosure.

FIG. 5G illustrates another schematic diagram of an edge pixel recognition scenario according to various disclosed embodiments of the present disclosure.

FIG. 6A illustrates a schematic diagram of a 0° reference image according to various disclosed embodiments of the present disclosure.

FIG. 6B illustrates a schematic diagram of a 450 reference image according to various disclosed embodiments of the present disclosure.

FIG. 6C illustrates a schematic diagram of a 900 reference image according to various disclosed embodiments of the present disclosure.

FIG. 7 illustrates a flowchart of matching and checking pixels in an image to be processed according to various disclosed embodiments of the present disclosure.

FIG. 8A illustrates a schematic diagram of an image to be processed after edge detection according to various disclosed embodiments of the present disclosure.

FIG. 8B illustrates a schematic diagram of a processed image after smoothing the image to be processed in FIG. 8A, according to various disclosed embodiments of the present disclosure.

FIG. 9A illustrates a schematic diagram of a halftone image before anti-aliasing processing according to various disclosed embodiments of the present disclosure.

FIG. 9B illustrates a schematic diagram of a halftone image after anti-aliasing processing using a data processing method according to various disclosed embodiments of the present disclosure.

FIG. 10A illustrates a schematic diagram of a halftone image after anti-aliasing processing using FIR filtering according to various disclosed embodiments of the present disclosure.

FIG. 10B illustrates a schematic diagram of a halftone image after anti-aliasing processing using a data processing method according to various disclosed embodiments of the present disclosure.

FIG. 11 illustrates a flowchart of an image forming method according to various disclosed embodiments of the present disclosure.

FIG. 12 illustrates an application scenario according to various disclosed embodiments of the present disclosure.

FIG. 13 illustrates an image forming device according to various disclosed embodiments of the present disclosure.

FIG. 14 illustrates an electronic device according to various disclosed embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. The embodiments disclosed herein are exemplary only. Other applications, advantages, alternations, modifications, or equivalents to the disclosed embodiments are obvious to those skilled in the art and are intended to be encompassed within the scope of the present disclosure.

It should be noted that the terms used in the embodiments of the present disclosure are only for the purpose of describing specific embodiments, and are not intended to limit the scope of the present disclosure. As used in the embodiments of the present disclosure and the appended claims, the singular forms such as “a”, “said” and “the” are also intended to include the plural forms unless the context clearly indicates otherwise.

It should be understood that the term “and/of” used in this specification is just for relationship description of related objects, indicating that there can be three kinds of relationships. For example, A and/or B, which can mean that A exists alone, A and B exist at the same time, and B exists alone. In addition, the character “/” in this specification generally indicates that the related objects are in an “of” relationship.

The terms “first”, “second”, etc. are used for descriptive purposes only and cannot be understood as indicating or implying relative importance or implicitly indicating the number of technical features indicated. Therefore, the features defined as “first” and “second” may explicitly or implicitly include at least one of the features. In the description of the present disclosure, the meaning of “multiple” is at least two, such as two, three, etc., unless otherwise clearly defined.

In the present disclosure, unless otherwise clearly defined, the terms “installed”, “connected”, “fixed”, etc. should be understood in a broad sense, for example, it can be a fixed connection, a detachable connection, or an integral body; it can be a mechanical connection; it can be directly connected, or indirectly connected through an intermediate medium, it can be the internal connection of two elements or the interaction relationship between two elements, unless otherwise clearly defined. For those skilled in the art, the specific meanings of the above terms in the present disclosure can be understood according to the specific circumstances.

In the present disclosure, unless otherwise clearly defined, the first feature “on” or “under” the second feature can be the first and second features directly contacting, or the first and second features indirectly contacting through an intermediate medium. Moreover, the first feature being “above” the second feature may mean that the first feature is directly above or obliquely above the second feature, or simply means that the first feature is higher in level than the second feature. The first feature being below the second feature may mean that the first feature is directly below or obliquely below the second feature, or simply means that the first feature is lower in level than the second feature.

Original image data refers to image data before halftone processing. For example, original image data may be 8-bit image data, and the pixel value of each pixel in the 8-bit image data may be 8-bit data. It can be understood that there are 256 gray levels (grayscales) in the 8-bit image data. For the convenience of description, in other parts of the present disclosure, the original image data may also be referred to as “original image”.

Halftone image data refers to image data whose tone value is expressed by the size or density of dots. Since dots are distributed discretely at a certain distance in space and there is always a certain limit to the number of network levels, the level change of the image cannot be continuously changed, so it is called a halftone image. Generally, the halftone image data includes 1-bit halftone image data and multi-bit halftone image data. Among them, the pixel value of each pixel in the 1-bit halftone image data is 1-bit data. It can be understood that there are 2 gray levels in the 1-bit halftone image data, which are 0 and 1. The pixel value of each pixel in the multi-bit halftone image data is data with more than 1-bit data. Exemplarily, the multi-bit halftone image data may be 2-bit halftone image data, 4-bit halftone image data, etc. It is understandable that the 2-bit halftone image data includes 4 gray levels, namely 00, 01, 10, and 11; the 4-bit halftone image data includes 16 gray levels, namely 0000, 0001, 0010, 0011, 0100, 0101, 0110, 0111, 1000, 1001, 1010, 1011, 1100, 1101, 1110, and 1111. Forease of description, in other parts of the present disclosure, the halftone image data may also be referred to as “halftone image”.

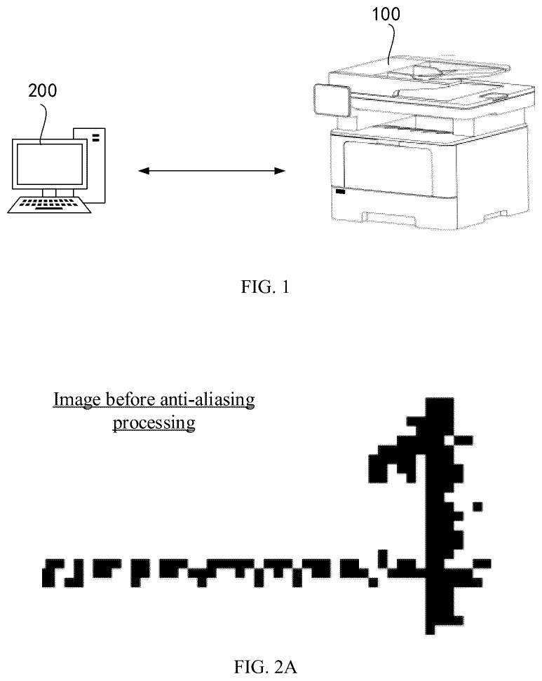

FIG. 1 is a schematic diagram of the structure of an image forming system provided in an embodiment of the present disclosure. As shown in FIG. 1, the image forming system may include an image forming device 100 and a terminal device 200. The image forming device 100 and the terminal device 200 may be interconnected through a wired or wireless communication network to transmit information. For example, a user may trigger an image forming operation on the terminal device 200, the terminal device 200 may respond to the image forming operation by sending data to be printed to the image forming device 100, and the image forming device 100 may perform an image forming operation (i.e., printing out a image) according to the data to be printed. Before the terminal device 200 sends the data to be printed to the image forming device 100 or after the image forming device 100 receives the data to be printed, it may be necessary to perform corresponding data processing such as format conversion on the data to be printed.

It should be pointed out that FIG. 1 is only an exemplary description provided by the present disclosure, and should not be regarded as a limitation on the scope of protection of the present disclosure. For example, the image forming device 100 may include but is not limited to a printer, a copier, a fax machine, a scanner, or a multifunctional peripheral that performs the above functions in a single device; and the terminal device 200 may include but is not limited to a mobile phone, a personal computer (PC), a personal digital assistant (PDA), a smartwatch, a netbook, etc.

The communication network between the image forming device 100 and the terminal device 200 may be a local area network or a wide area network transferred through a relay device. When the communication network is a local area network, illustratively, the communication network may be a short-range communication network such as a wifi hotspot network, a wifi P2P network, a Bluetooth network, a zigbee network, or a near field communication (NFC) network. When the communication network is a wide area network, illustratively, the communication network may be a third-generation mobile communication technology (3G) network, a fourth-generation mobile communication technology (4G) network, a fifth-generation mobile communication technology (5G) network, a future evolved public land mobile network (PLMN) or the Internet, etc.

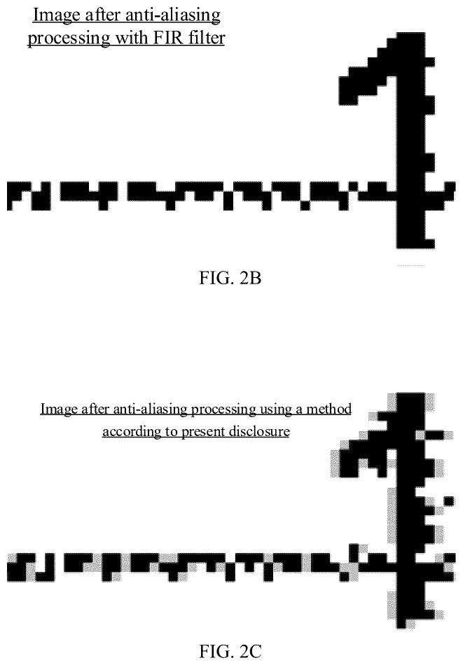

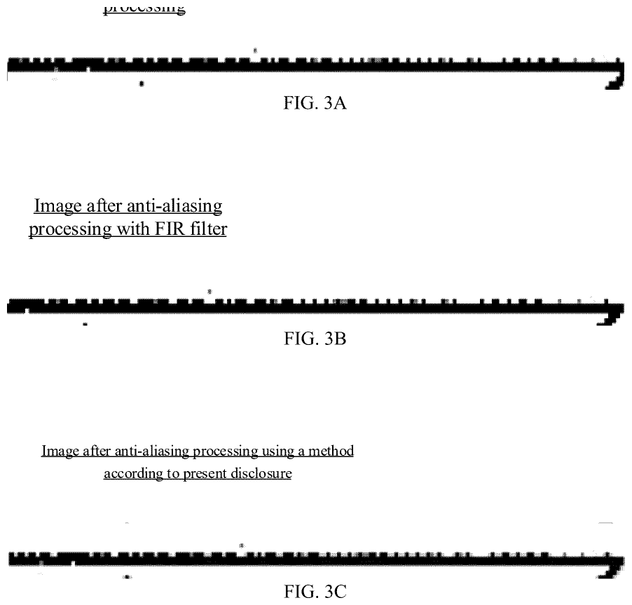

Before performing an image forming operation, an image forming device usually needs to convert the original image data into halftone image data through halftone processing, and then perform the image forming operation based on the halftone image data. However, halftone processing will make the edge pixels in the image brighter, thereby generating sawteeth, as shown in FIG. 2A and FIG. 3A.

To process the aliased image, a finite impulse response (FIR) filter is used to perform anti-aliasing processing on the original image to obtain an anti-aliasing processed image, as shown in FIG. 2B and FIG. 3B. However, since the original image has a large number of bits and the FIR filter requires a large number of tedious and complex calculations, the anti-aliasing processing of the original image has relatively high requirements on chip performance and occupies a large amount of memory.

The present disclosure provides a data processing method for performing anti-aliasing processing on a halftone image to obtain an anti-aliasing processed image, to at least partially alleviate the above problems, as shown in FIG. 2C and FIG. 3C. Since the halftone image has a small number of bits, the anti-aliasing processing of the halftone image may have relatively low requirements on chip performance and occupy a small amount of memory.

Also, by comparing FIG. 2B with FIG. 2C and FIG. 3B with FIG. 3C, it may be found that the image edge obtained by anti-aliasing processing the halftone image may be smoother and the processing effect may be better. Therefore, in some application scenarios, when the image processing effect is not ideal after anti-aliasing processing is performed on the original image, after converting the original image into a halftone image, it may be necessary to perform anti-aliasing processing on the halftone image again, such that the anti-aliasing processing effect is better and the image edge is smoother. In some other application scenarios, the image processing effect is not ideal after anti-aliasing processing is performed on the original image and the halftone processed image may make the sawtooth brighter even when halftone processing is performed after anti-aliasing processing. Therefore, by converting the original image into the halftone image and then performing anti-aliasing processing on the halftone image, the anti-aliasing processing effect may be better and the image edge may be smoother.

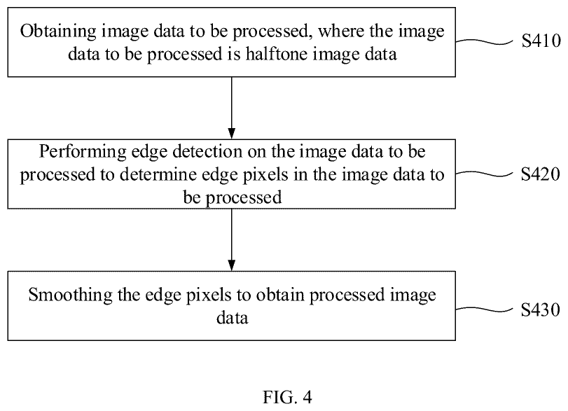

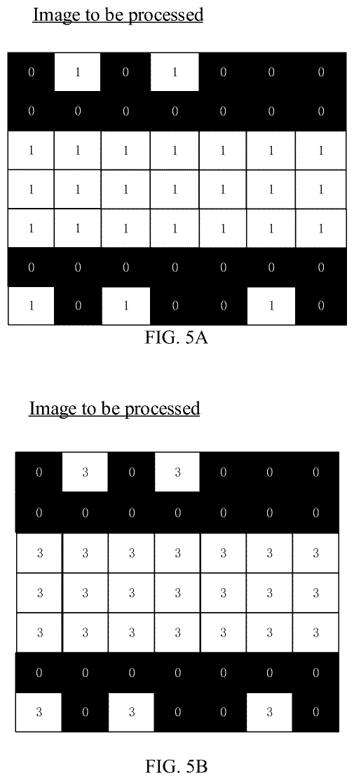

In one embodiment shown in FIG. 4 which is a flowchart of a data processing method according to the present disclosure, the data processing method may be applied to the terminal device or the image forming device in FIG. 1, and may include S410 to S430.

In S410, image data to be processed may be obtained. The image data to be processed may be halftone image data.

In one embodiment, the original image data may be converted into halftone image data, i.e., image data to be processed, according to a mapping relationship between the original image data and the halftone image data. In one embodiment of the present disclosure, the image data to be processed may be 1-bit halftone image data, or may be multi-bit halftone image data. The multi-bit halftone image data may be 2-bit halftone image data or 4-bit halftone image data.

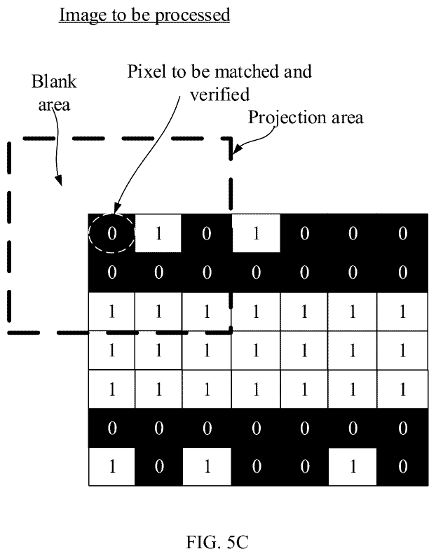

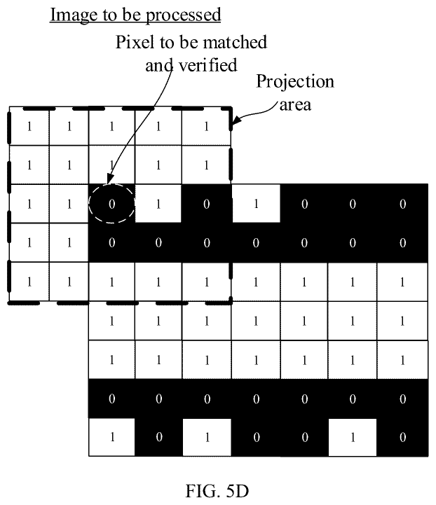

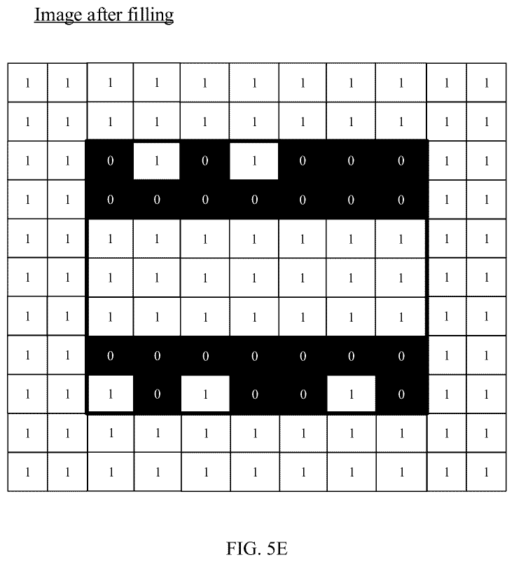

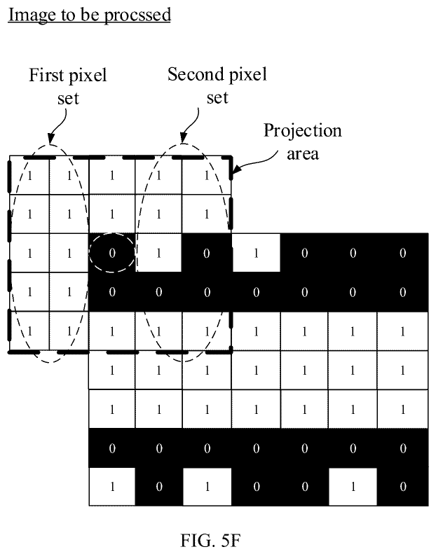

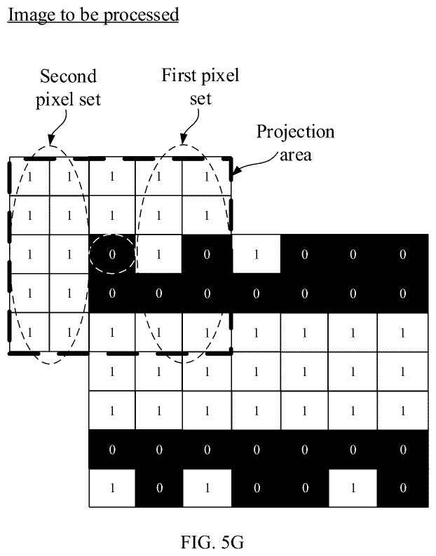

In some embodiments, to reduce sawteeth in the image data to be processed, when the image data to be processed is 1-bit halftone image data, the 1-bit halftone image data may be converted into multi-bit halftone image data, and then edge detection may be performed in subsequent steps. Exemplarily, the image to be processed shown in FIG. 5A may be a 1-bit halftone image. The 1-bit halftone image shown in FIG. 5A may be converted into a 2-bit halftone image, as shown in FIG. 5B. In another embodiment, edge detection may be performed on the 1-bit halftone image data first, and then the 1-bit halftone image may be converted into a multi-bit halftone image. The order of the halftone image conversion and edge detection steps may be selected according to actual needs, and the present disclosure does not impose specific restrictions on this.

It should be noted that, in some other embodiments, those skilled in the art may also directly perform edge detection in subsequent steps using the 1-bit halftone image data according to actual needs, and the present disclosure does not impose specific restrictions on this.

In S420, edge detection may be performed on the image data to be processed to determine edge pixels in the image data to be processed.

In some embodiments, edge detection may be performed on the image data to be processed by using a reference image to determine edge pixels in the image data to be processed. The reference image may be an image with edge features.

In one embodiment, the reference image may be an image with specific data distribution features. The reference image may be used as a sliding window to traverse the image to be processed, and the edge pixels in the image data to be processed may be determined in conjunction with a specific discrimination algorithm. For example, the reference image may be used as a sliding window to perform a matching verification on each pixel in the image to be processed to obtain a matching verification result for each pixel, and, when the matching verification result of one pixel in the image to be processed meets the preset edge feature condition, the pixel may be determined to be an edge pixel.

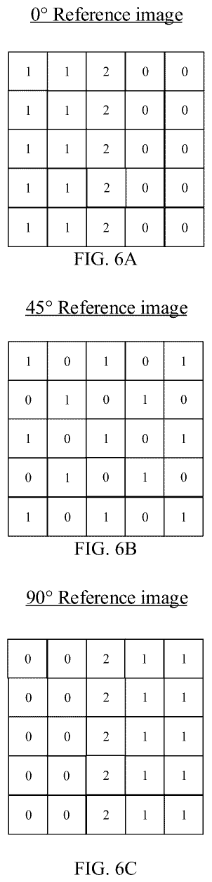

It should be supplemented that one reference image may include a corresponding edge angle, and the edge angle corresponding to the reference image may be related to the data distribution feature in the reference image. Exemplarily, as shown in FIG. 6A to FIG. 6C which are schematic diagrams of a reference image provided in an embodiment of the present disclosure, the edge angle corresponding to the reference image shown in FIG. 6A is 0°; the edge angle corresponding to the reference image shown in FIG. 6B is 45°; and the edge angle corresponding to the reference image shown in FIG. 6C is 90°.

In practical applications, the edges in the image to be processed may have different angles or extension directions. When only one reference image is used to perform edge detection on the image data to be processed, the detection effect of the edges corresponding to the edge angle of the reference image may be better, and the detection effect of other edges may be poor. Exemplarily, the edges in the image to be processed may include the horizontal direction (0°) and the vertical direction (90°). When a 0° reference image is used to perform edge detection on the image to be processed, the edge detection effect in the horizontal direction may be better, and the edge detection effect in the vertical direction may be poor.

To alleviate the above problem, in one embodiment, multiple reference images corresponding to different edge angles may be used as sliding windows, and matching verification may be performed on each pixel in the image to be processed respectively, and multiple matching verification results corresponding to each pixel may be obtained. When any matching verification result of one pixel in the image to be processed meets the preset edge feature condition, the pixel may be determined to be an edge pixel. Exemplarily, with the 0° reference image and the 90° reference image as sliding windows, each pixel in the image to be processed may be matched and verified respectively, and the first matching verification result (matching verification result corresponding to the 0° reference image) and the second matching verification result (matching verification result corresponding to the 90° reference image) corresponding to each pixel may be obtained. When any of the first matching verification result and the second matching verification result corresponding to a certain pixel meets the preset edge feature condition, the pixel may be determined to be an edge pixel.

One reference image in the present disclosure may be obtained by experience, that is, the data distribution characteristics in the reference image may be determined by experience. It is understandable that with the advancement of technology or the needs of certain specific application scenarios, the data distribution characteristics in the reference image may be further optimized and adjusted. Further, in some other embodiments, those skilled in the art may also set reference images of other angles according to actual needs, for example, 30° or 60°, etc.; or adjust the size of the reference image, for example, adjust the size of the reference image to a 3*3, 6*6 or 4*5 data block, etc., and the embodiment of the present disclosure does not impose specific restrictions on this.

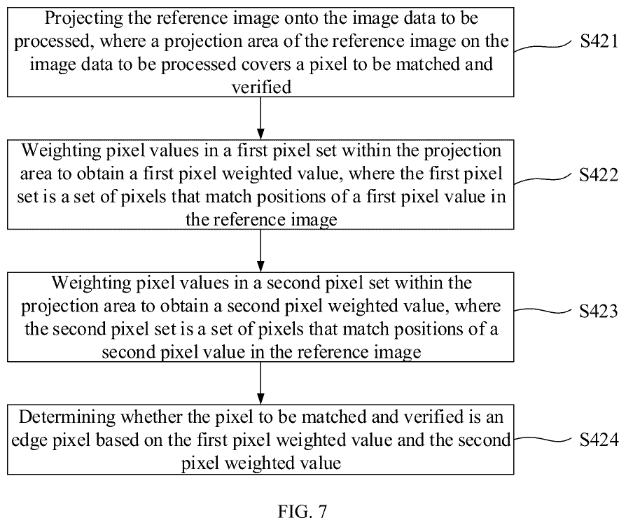

As shown in FIG. 7, which is a flow chart of matching verification of pixels in the image to be processed; in one embodiment, match verification may mainly include S421 to S424.

In S421, one reference image may be projected onto the image to be processed, where the projection area of the reference image on the image to be processed covers the pixels to be matched and verified.

The area where the reference image is projected onto the image to be processed is referred to as the “projection area”. It is understood that the size of the projection area is equal to the size of the data block corresponding to the reference image. Exemplarily, when the reference image is a 5*5 data block, the projection area of the reference image on the image to be processed may also be a 5*5 area.

It is understood that the projection area of the reference image on the image to be processed should cover the pixels to be matched and verified, to perform matching verification on the pixels to be matched and verified. Exemplarily, the reference image shown in FIGS. 6A-6C may be used as a sliding window, starting from the first row and first column pixel (1, 1) in the image to be processed shown in FIG. 5A, the pixels in the image to be processed may be traversed. When the pixel to be matched and verified is pixel (1, 1), the projection area of the reference image on the image to be processed may cover pixel (1, 1), as shown in FIG. 5C.

It should be noted that in the application scenario shown in FIG. 5C, the pixel to be matched and verified may be located at the center of the projection area. Of course, those skilled in the art may also adjust the position of the pixel to be matched and verified in the projection area according to actual needs. For example, the position of the pixel to be matched and verified in the projection area may be adjusted to a position slightly above, slightly below, slightly to the left, or slightly to the right, and the embodiment of the present disclosure does not impose specific restrictions on this. Those skilled in the art should understand that when the pixel to be matched and verified is located at the center of the projection area, it may be possible to better combine the pixels around the pixel to be matched and verified to determine whether the pixel to be matched and verified is an edge pixel, that is, to obtain a more accurate matching verification result.

In S422, the pixel values of a first pixel set in the projection area may be weighted to obtain a first pixel weighted value, where the first pixel set is a set of pixels that match the position of the first pixel value in the reference image.

In one embodiment, the first pixel value may be “1”. Accordingly, the first pixel set may be a set of pixels that match the position of “1” in the reference image.

It can be understood that when the pixel to be matched and verified is located at the edge of the image to be processed, there may usually be a blank area in the projection area of the reference image on the image to be processed, resulting in a small number of pixels in the projection area, thereby affecting the statistics of the pixel values. Exemplarily, in the application scenario shown in FIG. 5C, there may be two columns of blank areas on the left side of the projection area, and two rows of blank areas on the upper side.

In one embodiment, when there are blank areas in the projection area, the blank areas may be first filled, and then the pixel values may be counted. For example, to avoid the impact of the added pixels on the original image, the pixel values corresponding to the brightest grayscale level may be filled in the blank areas by default. Exemplarily, in the application scenario shown in FIG. 5C, the pixel value corresponding to the brightest grayscale level is “1”, and then all pixels in the blank area may be filled with the pixel value “1”, and the obtained filled projection area is shown in FIG. 5D. It can be understood that for a 2-bit halftone image, the pixel value corresponding to the brightest grayscale level may be “3”, and then the pixel value filled in the blank area may be “3”.

In the process of traversing the pixels in the image to be processed, as the sliding window (the reference image) slides on the image to be processed, the blank areas on the upper side, lower side, left side, and right side of the image to be processed may be filled in turn, and the obtained filled image may be as shown in FIG. 5E. That is, two rows of pixels with a pixel value of 1 may be added to the upper side and lower side of the image to be processed, and two columns of pixels with a pixel value of 1 may be added to the left and right sides of the image to be processed.

Further, after the filling of the projection area is completed, the first pixel set in the projection area may be determined according to the positions of the first pixel value in the reference image, and then the pixel values in the first pixel set may be weighted to obtain the first pixel weighted value.

Exemplarily, the 0° reference image shown in FIG. 6A may be used as the sliding window, starting from the first row and first column pixel (1, 1) in the image to be processed shown in FIG. 5A, the pixels in the image to be processed may be traversed. When the pixel to be matched is pixel (1, 1), the first pixel set in the projection area may be determined according to the position of the first pixel value “1” in the 0° reference image as shown in FIG. 5F, that is, the first pixel set may include the pixel points in the two left columns of the projection area. The pixel values in the first pixel set may be weighted to obtain a first pixel weighted value A1′=1+1+1+1+1+1+1+1+1+1+1=10.

In another embodiment, a first preset value A1 may also be set, and the first preset value A1 and the pixel values in the first pixel set may be weighted to obtain the first pixel weighted value A1′. According to this algorithm, in the application scenario shown in FIG. 5F, the first pixel weighted value may be A1′=A1+1+1+1+1+1+1+1+1+1+1+1=A1+10. It should be pointed out that those skilled in the art may adjust the value of the first preset value A1 according to actual needs, and the embodiment of the present disclosure does not impose specific restrictions on this.

Exemplarily, taking the 90° reference image shown in FIG. 6C as a sliding window, starting from the pixel (1, 1) in the first row and first column of the image to be processed shown in FIG. 5A, the pixels in the image to be processed may be traversed. When the pixel to be matched and verified is pixel (1, 1), the first pixel set in the projection area may be determined according to the position of the first pixel value “1” in the 90° reference image as shown in FIG. 5G, that is, the first pixel set may include the pixel points in the two right columns in the projection area. The pixel values in the first pixel set may be weighted, and the first pixel weighted value A2′=1+1+1+0+1+1+1+0+0+1=7 may be obtained.

In one embodiment, a first preset value A2 may also be set, and the first preset value A2 may be weighted with the pixel values in the first pixel set to obtain the first pixel weighted value A2′. According to this algorithm, in the application scenario shown in FIG. 5G, the first pixel weighted value may be A2′=A2+1+1+1+0+1+1+1+0+0+1=A2+7. It should be pointed out that those skilled in the art may adjust the value of the first preset value A2 according to actual needs, and the embodiment of the present disclosure does not impose specific restrictions on this.

In S423, the pixel values of a second pixel set in the projection area may be weighted to obtain a second pixel weighted value, where the second pixel set is a set of pixels that match the position of the second pixel value in the reference image.

In one embodiment, the second pixel value may be “0”. Accordingly, the second pixel set may be a set of pixels that match the position of “0” in the reference image. The second pixel set in the projection area may be determined according to the positions of the second pixel value in the reference image, and then the pixel values in the second pixel set may be weighted to obtain the second pixel weighted value.

Exemplarily, the 0° reference image shown in FIG. 6A may be used as the sliding window, starting from the first row and first column pixel (1, 1) in the image to be processed shown in FIG. 5A, the pixels in the image to be processed may be traversed. When the pixel to be matched is pixel (1, 1), the second pixel set in the projection area may be determined according to the position of the second pixel value “0” in the 0° reference image as shown in FIG. 5F, that is, the second pixel set may include the pixel points in the two right columns of the projection area. The pixel values in the second pixel set may be weighted to obtain a second pixel weighted value B1′=1+1+1+0+1+1+1+0+0+1=7.

In another embodiment, a second preset value B1 may also be set, and the second preset value B1 and the pixel values in the second pixel set may be weighted to obtain the second pixel weighted value B1′. According to this algorithm, in the application scenario shown in FIG. 5F, the second pixel weighted value may be B1′=B1+1+1+1+0+1+1+1+0+0+1=B1+7. It should be pointed out that those skilled in the art may adjust the value of the second preset value B1 according to actual needs, and the embodiment of the present disclosure does not impose specific restrictions on this.

Exemplarily, taking the 90° reference image shown in FIG. 6C as a sliding window, starting from the pixel (1, 1) in the first row and first column of the image to be processed shown in FIG. 5A, the pixels in the image to be processed may be traversed. When the pixel to be matched and verified is pixel (1, 1), the second pixel set in the projection area may be determined according to the position of the second pixel value “0” in the 90° reference image as shown in FIG. 5G, that is, the second pixel set may include the pixel points in the two left columns in the projection area. The pixel values in the second pixel set may be weighted, and the second pixel weighted value B2′=1+1+1+1+1+1+1+1+1+1=10 may be obtained.

In one embodiment, a second preset value B2 may also be set, and the second preset value B2 may be weighted with the pixel values in the second pixel set to obtain the second pixel weighted value B2′. According to this algorithm, in the application scenario shown in FIG. 5G, the second pixel weighted value may be B2′=B2+1+1+1+1+1+1+1+1+1+1=B2+10. It should be pointed out that those skilled in the art may adjust the value of the second preset value B2 according to actual needs, and the embodiment of the present disclosure does not impose specific restrictions on this.

In S424, whether the pixel to be matched and verified is an edge pixel may be determined according to the first pixel weighted value and the second pixel weighted value.

In one embodiment, the edge pixel judgment condition may include that: the first pixel weighted value is less than the second pixel weighted value. Therefore, after obtaining the first pixel weighted value and the second pixel weighted value, the first pixel weighted value and the second pixel weighted value may be compared. When the first pixel weighted value is less than the second pixel weighted value, the pixel to be matched and verified may be determined to be an edge pixel; otherwise, it may be determined that the pixel to be matched and verified is not an edge pixel.

Exemplarily, when the 0° reference image shown in FIG. 6A is used as a sliding window to perform matching verification on the image to be processed shown in FIG. 5A, the first pixel weighted value may be A1′ and the second pixel weighted value may be B1′. Therefore, in this application scenario, the edge pixel judgment condition may be: A1′<B1′. As described above, for the pixel (1, 1) in the image to be processed, the first pixel weight value A1′=10, the second pixel weight value B1′=7, which does not satisfy A1′<B1′, so it may be determined that the pixel (1, 1) is not an edge pixel.

When the 90° reference image shown in FIG. 6C is used as a sliding window to perform matching verification on the image to be processed shown in FIG. 5A, the first pixel weight value is A2′, and the second pixel weight value is B2′. Therefore, in this application scenario, the judgment condition of the edge pixel may be: A2′<B2′. As described above, for the pixel (1, 1) in the image to be processed, the first pixel weight value A2′=7, the second pixel weight value B2′=10, which satisfies A2′<B2′, so it may be determined that the pixel (1, 1) is an edge pixel.

As described above, to improve the edge detection effect of the image to be processed, the multiple reference images corresponding to different edge angles may be used as sliding windows to perform matching verification on each pixel in the image to be processed, and obtain multiple matching verification results corresponding to each pixel. When any matching verification result of one pixel in the image to be processed meets the preset edge feature condition, the pixel may be determined to be an edge pixel.’

When the 0° reference image shown in FIG. 6A and the 90° reference image shown in FIG. 6C are used as sliding windows to perform matching verification on the image to be processed shown in FIG. 5A, respectively, the judgment condition of the edge pixel may be: A1′<B1′ or A2′<B2′. As described above, for the pixel (1, 1) in the image to be processed, the first pixel weight value A1=10, the second pixel weight value B1′=7; the first pixel weight value A2′=7, the second pixel weight value B2′=10. Therefore, A1′<B1′ or A2′<B2′ may be satisfied, and the pixel (1, 1) may be determined to be an edge pixel.

In one embodiment, determining whether the pixel to be matched and verified is an edge pixel according to the first pixel weight value and the second pixel weight value may include: weighting the pixel value of each pixel in the projection area to obtain a third pixel weight value; determining whether the pixel to be matched and verified is an edge pixel according to the first pixel weight value, the second pixel weight value, and the third pixel weight value. When the first pixel weight value is less than the second pixel weight value, and the third pixel weight value is greater than or equal to a third preset value, the pixel to be matched and verified may be determined to be an edge pixel; otherwise, the pixel to be matched and verified may be determined not to be an edge pixel.

In this embodiment, the influence of the third pixel weighted value on the edge pixels may be taken into consideration, and the edge pixels may be judged in combination with the third pixel weighted value, such that the edge detection effect of the image to be processed may be improved.

For the convenience of description, in the following, the third pixel weighted value is denoted as C, and the third preset value is denoted as n*3. It should be pointed out that the value of n will affect the number of edge pixels detected. The smaller n is, the more edge pixels are detected, and the more obvious the processing effect on the image to be processed is; the larger n is, the fewer edge pixels are detected, and the less obvious the processing effect on the image to be processed is. The value of n may be set by the user or by the technician before leaving the factory, and the embodiment of the present disclosure does not impose specific restrictions on this.

For example, when the 0° reference image shown in FIG. 6A may be used as a sliding window to perform matching verification on the image to be processed shown in FIG. 5A, the first pixel weighted value may be A1′, and the second pixel weighted value may be B1′. In this application scenario, the judgment condition of the edge pixel may be: A1′<BF and C>n*3. For the pixel (1, 1) in the image to be processed, the first pixel weight value A1′=10, the second pixel weight value B1′=7, and the third pixel weight value C=20. When n is 2, that is, n*3=6, then A1′<B1′ and C>n*3 may not be satisfied, so it may be determined that the pixel (1, 1) is not an edge pixel.

When the 90° reference image shown in FIG. 6C may be used as a sliding window to perform matching verification on the image to be processed shown in FIG. 5A, the first pixel weight value may be A2′ and the second pixel weight value may be B2′. In this application scenario, the judgment condition of the edge pixel is: A2′<B2′ and C>n*3. For the pixel (1, 1) in the image to be processed, the first pixel weight value A2′=7, the second pixel weight value B2′=10, and the third pixel weight value C=20. If n is 2, that is, n*3=6, A2′<B2′ and C>n*3 may be satisfied, so the pixel (1, 1) may be determined to be an edge pixel.

When the 0° reference image shown in FIG. 6A and the 90° reference image shown in FIG. 6C are used as sliding windows to perform matching verification on the image to be processed shown in FIG. 5A, the judgment conditions of the edge pixel are: A1′<B1′ and C>n*3, or A2′<B2′ and C>n*3.

For the pixel (1, 1) in the image to be processed, A1′=10, B1′=7, A2′=7, B2′=10, C=20, A1′<B1′ and C>n*3, or A2′<B2′ and C>n*3 are satisfied, and the pixel (1, 1) is determined to be an edge pixel.

For the pixel (1, 2) in the image to be processed, A1′=8, B1′=7, A2′=7, B2′=8, C=19, A1′<B1′ and C>n*3, or A2′<B2′ and C>n*3 are satisfied, and the pixel (1, 2) is determined to be an edge pixel.

For pixel (1, 3) in the image to be processed, A1′=7, B1′=7, A2′=7, B2′=7, C=18, A1′<B1′ and C>n*3, or A2′<B2′ and C>n*3 are not satisfied, and thus pixel (1, 3) is determined not to be an edge pixel.

For pixel (1, 4) in the image to be processed, A1′=7, B1′=6, A2′=6, B2′=7, C=17, A1′<B1′ and C>n*3, or A2′<B2′ and C>n*3 are satisfied, and thus pixel (1, 4) is determined to be an edge pixel.

For the pixel (1, 5) in the image to be processed, A1′=7, B1′=6, A2′=6, B2′=7, C=16, A1′<B1′ and C>n*3, or A2′<B2′ and C>n*3 are satisfied, and the pixel (1, 5) is determined to be an edge pixel.

For the pixel (1, 6) in the image to be processed, A1′=7, B1′=8, A2′=8, B2′=7, C=18, A1′<B1′ and C>n*3, or A2′<B2′ and C>n*3 are satisfied, and the pixel (1,6) is determined to be an edge pixel.

For the pixel (1, 7) in the image to be processed, A1′=6, B1′=10, A2′=10, B2′=6, C=19, A1′<B1′ and C>n*3, or A2′<B2′ and C>n*3, and the pixel (1, 7) is determined to be an edge pixel.

By analogy, the traversal of the image to be processed may be completed, and all edge pixels in the image to be processed may be determined, which will not be described in detail in the embodiment of the present disclosure.

In S430, the pixel values of the pixels within the preset range may be smoothed to obtain processed image data.

In one embodiment, taking one edge pixel as the center, the pixel values of the pixels within the preset range may be smoothed to obtain the processed image data. Before smoothing the image to be processed, it may be determined whether the image to be processed is a 1-bit halftone image or a multi-bit halftone image. When the image to be processed is a 1-bit halftone image, the image to be processed may be converted into a multi-bit halftone image, and then the image to be processed may be smoothed. Since the multi-bit halftone image has more gray levels, the selectivity of filling points may be more in the process of smoothing the multi-bit halftone image, which may make the edges of the image to be processed smoother.

In one embodiment, taking one edge pixel as the center, smoothing the pixel values of the pixels within the preset range may include: taking the edge pixel as the center, respectively calculating the pixel weighted average value of each adjacent pixel of the edge pixel and the edge pixel; rounding the pixel weighted average value and assigning it to the corresponding adjacent pixel to obtain the processed image data. One adjacent pixel may be a pixel adjacent to the edge pixel. Exemplarily, the adjacent pixel may be 3, the edge pixel may be 0, the pixel weighted average of the adjacent pixel and the edge pixel may be 1.5, and the pixel value obtained after rounding down the pixel weighted average may be 1, therefore 1 may be assigned to the adjacent pixel. Alternatively, the pixel value obtained after rounding up the pixel weighted average may be 2 and 2 may be assigned to the adjacent pixel.

It can be understood that rounding the pixel weighted average of the adjacent pixel and the edge pixel and assigning it to the adjacent pixel may make the transition between the adjacent pixel and the edge pixel smoother, thereby improving the smoothness of the edges.

Further, since the pixels that have the greatest impact on the edge smoothness of the processed image are the aliasing pixels, to reduce the amount of data processing and avoid excessive processing of the original data in the processed image to cause distortion of the processed image, only the aliasing pixels may be filled. With the edge pixel as the center, it may be determined whether one adjacent pixel of the edge pixel is an aliasing pixel in the extension direction of the edges. When the adjacent pixel is an aliasing pixel, the pixel weighted average of the aliasing pixel and the edge pixel may be calculated. The pixel weighted average may be rounded and assigned to the corresponding aliasing pixel. When the adjacent pixel is not an aliasing pixel, the adjacent pixel may not be processed.

In one embodiment, the determination condition of the aliasing pixel may include that: the pixel value of the aliasing pixel is the pixel value corresponding to the brightest grayscale level, and at least one of the adjacent pixels of the aliasing pixel has a pixel value corresponding to the darkest grayscale level in the extension direction perpendicular to the edge. It can be understood that for a 2-bit halftone image, the pixel value corresponding to the brightest grayscale level is 3, and the pixel value corresponding to the darkest grayscale level is 0, and the aliased pixel determination condition may include that: the pixel value of the aliasing pixel is 3, and at least one of the adjacent pixels of the aliasing pixel has a pixel value of 0.

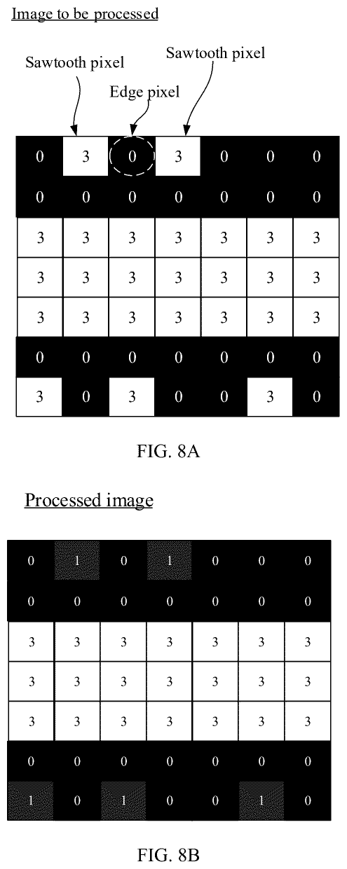

Exemplarily, in the image to be processed shown in FIG. 8A, the pixel (1, 3) in the 1st row and the 3rd column may be an edge pixel. In the extension direction of the edge (the horizontal direction shown in FIG. 8A), it may be determined whether the adjacent pixel (1, 2) on the left side of the edge pixel (1, 3) is an aliasing pixel. The pixel value of the adjacent pixel (1, 2) is 3, and in the extension direction perpendicular to the edge (the vertical direction shown in FIG. 8A), the pixel value of the pixel (2, 2) below the adjacent pixel (1, 2) is 0. Then, according to the above-mentioned judgment condition of the aliasing pixel, the adjacent pixel (1, 2) on the left side of the edge pixel (1, 3) may be determined to be an aliasing pixel. After determining that the adjacent pixel (1, 2) on the left side of the edge pixel (1, 3) is an aliasing pixel, the pixel value 0 of the edge pixel (1, 3) and the pixel value 3 of the adjacent pixel (1, 2) may be added and the average value may be obtained, and the obtained pixel weighted average value may be 1.5. The pixel value obtained after rounding down the pixel weighted average may be 1, and 1 may be assigned to the adjacent pixel (1, 2).

Similarly, it may be determined whether the adjacent pixel (1, 4) to the right of the edge pixel (1, 3) is an aliasing pixel. The pixel value of the adjacent pixel (1, 4) is 3, and in the extension direction perpendicular to the edge (the vertical direction shown in FIG. 8A), the pixel value of the pixel (2, 4) below the adjacent pixel (1, 4) is 0, then the adjacent pixel (1, 4) to the right of the edge pixel (1, 3) may be determined to be an aliasing pixel according to the above-mentioned judgment condition of the aliasing pixel. After determining that the adjacent pixel (1, 4) to the right of the edge pixel (1, 3) is an aliasing pixel, the pixel value 0 of the edge pixel (1, 3) and the pixel value 3 of the adjacent pixel (1, 4) may be added and averaged, and the obtained pixel weighted average may be 1.5. The pixel value obtained after rounding down the pixel weighted average may be 1 and 1 may be assigned to the adjacent pixel (1, 4).

After traversing the edge pixels in the image to be processed shown in FIG. 8A using the above method, the processed image as shown in FIG. 8B may be obtained. Comparing FIG. 8A and FIG. 8B, it can be seen that the edge of the processed image is smoother.

In the present disclosure, since the bit number of the halftone image is small, the anti-aliasing processing of the halftone image may have relatively low chip performance requirements and occupy less memory.

Also, compared with the anti-aliasing processing of the original image by FIR filtering, the image edge obtained by converting the original image into a halftone image and then performing anti-aliasing processing may be smoother and the processing effect may be better.

It can be understood that, as shown in FIG. 4, each pixel value in the image to be processed may be processed accordingly in turn. For example, after determining that a certain pixel is an edge pixel, the pixel values of the pixels within a preset range may be smoothed with the edge pixel as the center, and then the next pixel value may be judged. However, the efficiency of this data processing method may be low.

In some embodiments, all edge pixels in the image to be processed may be determined first, and then all edge pixels may be smoothed in a centralized manner. It can be understood that in this data processing method, the positions of the detected edge pixels may need to be recorded. For example, a reference image of the same size as the image to be processed may be created, and the pixel values of all pixels in the reference image may be set to 3. When edge pixels are detected in the image to be processed, the pixel values of the pixels corresponding to the edge pixels in the reference image may be set to 0, thereby marking the edge pixel positions. Through the above method, all edge pixels may be marked in the reference image, and then all edge pixels may centrally be smoothed in subsequent steps to improve data processing efficiency.

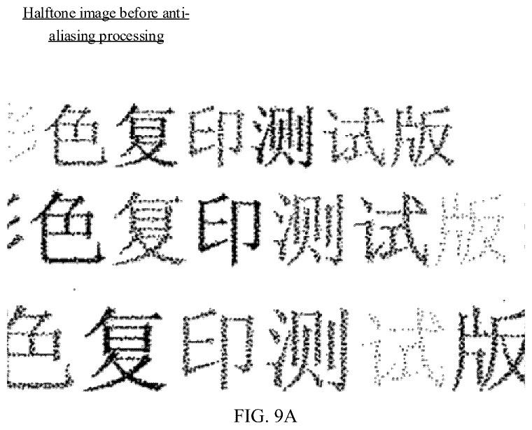

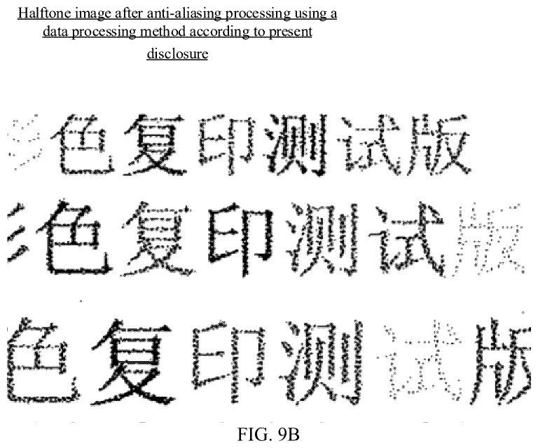

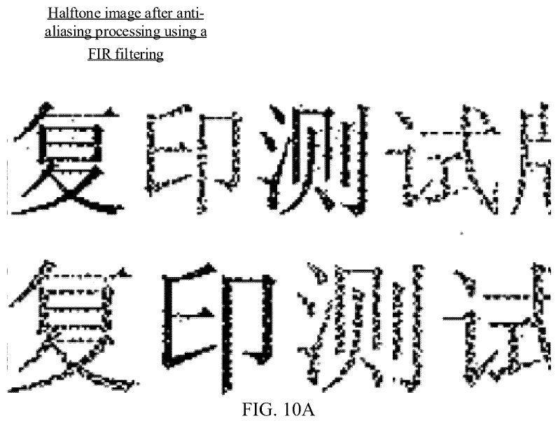

As shown in FIG. 9A which is a schematic diagram of a halftone image before anti-aliasing processing and FIG. 9B which is a schematic diagram of a halftone image after anti-aliasing processing using the method provided in the present disclosure, it can be found that after anti-aliasing processing using the method provided in the present disclosure, the edge of the images may be smoother and more delicate.

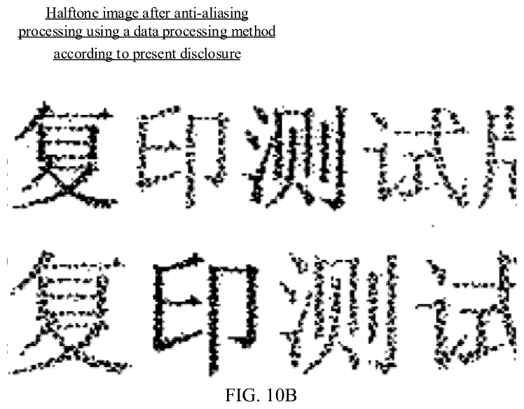

As shown in FIG. 10A which is a schematic diagram of a halftone image after anti-aliasing processing using FIR filtering and FIG. 10B which is a schematic diagram of a halftone image after anti-aliasing processing using the method provided in the present disclosure, it can be found that compared with FIR filtering, the edges of the image may be smoother and more delicate after anti-aliasing processing using the method provided in the present disclosure.

The present disclosure also provides an image forming method.

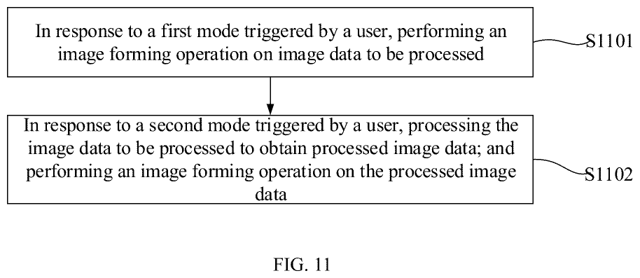

As shown in FIG. 11 which a flow chart of an image forming method consistent with the present disclosure, the method may include S1101 and S1102.

In S1101, in response to a first mode triggered by a user, an image forming operation may be performed on image data to be processed.

In one embodiment, the first mode may refer to not performing anti-aliasing processing on the image to be processed and directly printing out the image based on the image to be processed. It may be understood that in the first mode, due to the small amount of data processing, the response speed of the image forming device may be fast. Therefore, when the user needs a faster response speed, the first mode may be triggered.

In S1102, in response to a second mode triggered by the user, the image data to be processed may be processed to obtain processed image data; and an image forming operation may be performed on the processed image data.

In one embodiment, the second mode may refer to performing anti-aliasing processing on the image to be processed using the method described in the above embodiments, and then printing out the image based on the processed image. It may be understood that in the second mode, the edge smoothness of the processed image may be better. Therefore, when the user needs a higher image quality, the second mode may be triggered.

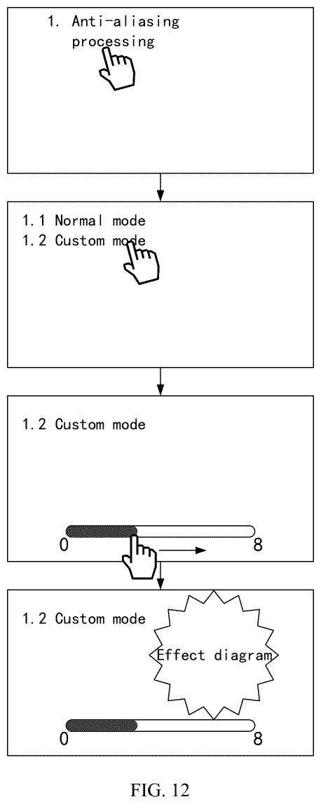

In one embodiment, the second mode may include a normal mode and a custom mode. Exemplarily, as shown in FIG. 12, when the user triggers the “anti-aliasing processing” control, a selection menu of “normal mode” and “custom mode” may be displayed in the display interface. In the normal mode, the image to be processed may be anti-aliased according to the third preset value of the system default. In the custom mode, the user may adjust the third preset value. As described above, the value of the third preset value may affect the number of edge pixels detected. The smaller the third preset value, the more edge pixels may be detected, and the more obvious the processing effect of the image to be processed. The larger the third preset value, the fewer edge pixels may be detected, and the less obvious the processing effect of the image to be processed. Therefore, in the custom mode, the user may adjust the image processing effect through the third preset value.

In one embodiment, when the user clicks the “custom mode” control, a progress bar of the third preset value may be displayed in the display interface, and the user may adjust the third preset value by dragging the progress bar. Exemplarily, when the user drags the progress bar to the right, the third preset value may gradually increase; and when the user drags the progress bar to the left, the third preset value may gradually decrease. It should be noted that the data (0, 8) indicated in the progress bar of FIG. 12 may be the value of n in the third preset value n*3 mentioned above. It may be understandable that the range of the third preset value indicated by the progress bar may be (0, 24).

Also, in the process of the user adjusting the third preset value, the effect diagram of the processed image may be displayed in real time in the display interface, such that the user may set the third preset value in a suitable range, and then print out an image that meets the user's expectations.

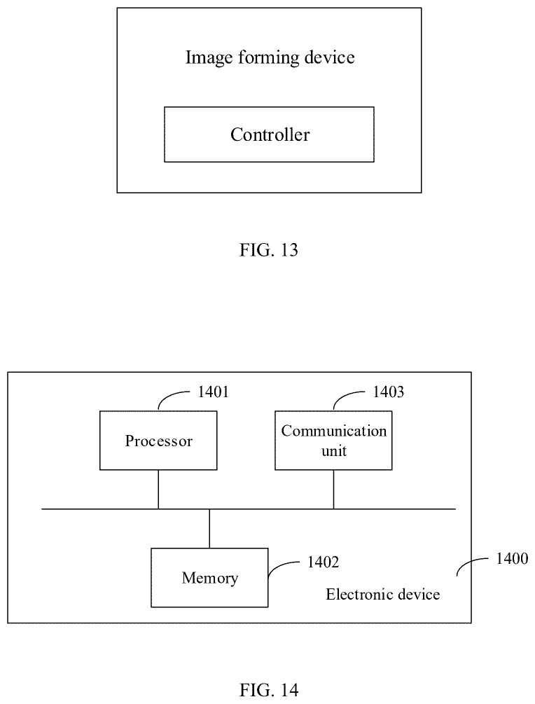

The present disclosure also provides an image forming device. As shown in FIG. 13 which a structural schematic diagram of an image forming device consistent with the present disclosure, in one embodiment, the image forming device may include a controller, and the controller may be configured to execute some or all of the steps in the above method embodiment.

It should be noted that the method steps executed by the controller may be referred to the description of the above method example, and for the sake of brevity, it will not be repeated here.

The present disclosure also provides an electronic device.

As shown in FIG. 14 which is a schematic diagram of the structure of an electronic device, in one embodiment, the electronic device 1400 may include: a processor 1401, a memory 1402, and a communication unit 1403. These components may communicate through one or more buses. It can be understood by those skilled in the art that the electronic device structure shown in the figure does not constitute a limitation on the scope of the present disclosure. It may be a bus structure or a star structure, and may also include more or fewer components than shown, or a combination of certain components, or different component arrangements.

The communication unit 1403 may be used to establish a communication channel such that the electronic device can communicate with other devices.

The processor 1401 may be the control center of the electronic device. The processor may use various interfaces and lines to connect various parts of the entire electronic device, and execute software programs and/or modules stored in the memory 1402, and call data stored in the memory to perform various functions of the electronic device and/or process data. The processor may include an integrated circuit (IC), for example, a single packaged IC or multiple packaged ICs with the same or different functions. For example, the processor 1401 may include only a central processing unit (CPU). The CPU may be a single computing core or may include multiple computing cores.

The memory 1402 may be used to store the execution instructions of the processor 1401. The memory 1402 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disk.

When the execution instructions in the memory 1402 are executed by the processor 1401, the electronic device 1400 may be enabled to perform some or all of the steps in the above method embodiments.

The present disclosure also provides a non-transitory computer-readable storage medium. The non-transitory computer-readable storage medium may store a program, where when the program is running, the device where the computer-readable storage medium is located may be controlled to perform some or all of the steps in the above method embodiments. The non-transitory computer-readable storage medium may be a disk, an optical disk, a read-only memory (ROM) or a random access memory (RAM), etc.

The present disclosure also provides a computer program product, which includes executable instructions. When the executable instructions are executed on a computer, the computer may execute some or all of the steps in the above method embodiments.

In the embodiment of the present disclosure, “at least one” refers to one or more, and “more” refers to two or more. “And/or” describes the association relationship of the associated objects, indicating that three relationships may exist. For example, A and/or B can represent the existence of A alone, the existence of A and B at the same time, and the existence of B alone. Among them, A and B can be singular or plural. The character “/” generally indicates that the associated objects before and after are in an “or” relationship. “At least one of the following” and similar expressions refer to any combination of these items, including any combination of singular or plural items. For example, at least one of a, b and c can represent: a, b, c, a-b, a-c, b-c, or a-b-c, where a, b, or c can be single or plural.

The embodiments disclosed herein are exemplary only. Other applications, advantages, alternations, modifications, or equivalents to the disclosed embodiments are obvious to those skilled in the art and are intended to be encompassed within the scope of the present disclosure. In some cases, the actions or steps recited in the present disclosure may be performed in an order different from that in the embodiments and still achieve desirable results. In addition, the processes depicted in the accompanying figures do not necessarily require the particular order shown, or sequential order, to achieve desirable results. Multitasking and parallel processing may be also possible or may be advantageous in certain embodiments.

Any process or method descriptions in flowcharts or otherwise described herein may be understood to represent modules, segments or portions of code comprising one or more executable instructions for implementing custom logical functions or steps of a process, and the scope of preferred embodiments of this specification includes alternative implementations in which functions may be performed out of the order shown or discussed, including in substantially simultaneous fashion or in reverse order depending on the functions involved.

In the present disclosure, the disclosed systems, devices or methods can be implemented in other ways. For example, the device embodiments described above are only illustrative. For example, the division of the units is only a logical function division. In actual implementation, there may be other division methods. For example, multiple units or components may be combined or may be integrated into another system, or some features may be ignored or not implemented. In another point, the mutual coupling or direct coupling or communication connection shown or discussed may be through some interfaces, and the indirect coupling or communication connection of devices or units may be in electrical, mechanical or other forms. Each functional unit in each embodiment of the present disclosure may be integrated into one processing unit, or each unit may exist separately physically, or two or more units may be integrated into one unit. The above-mentioned integrated units can be implemented in the form of hardware, or in the form of hardware plus software functional units.

The integrated units implemented in the form of software functional units may be stored in a non-transitory computer-readable storage medium. The above-mentioned software functional units may be stored in a storage medium, including several instructions to enable a computer device (which may be a personal computer, a connector, or a network device, etc.) or a processor to execute a portion of the methods described in each embodiment of the present disclosure. The aforementioned storage media may include medium that can store program code such as a flash disk, a mobile hard disk, read-only memory (ROM), random access memory (RAM), magnetic disk or optical disc, etc.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A data processing method, comprising:
obtaining image data to be processed, wherein the image data to be processed is halftone image data;
performing edge detection on the image data to be processed to determine edge pixels in the image data to be processed; and
smoothing the edge pixels to obtain processed image data.

2. The method according to claim 1, wherein performing the edge detection on the image data to be processed to determine the edge pixels in the image data to be processed includes:
performing the edge detection on the image data to be processed through reference images to determine the edge pixels in the image data to be processed, wherein one reference image is an image with edge features.

3. The method according to claim 1, wherein smoothing the edge pixels to obtain the processed image data includes:
taking the edge pixels as centers to smooth pixel values of pixels within a preset range to obtain the processed image data.

4. The method according to claim 2, wherein performing the edge detection on the image data to be processed through the reference images to determine the edge pixels in the image data to be processed includes:
taking each reference image as sliding windows, performing matching verification on each pixel in the image data to be processed to obtain a matching verification result for each pixel; and
when the matching verification result of one pixel in the image data to be processed meets a preset edge feature condition, determining the pixel to be an edge pixel.

5. The method according to claim 4, wherein the matching verification includes:
projecting the reference image onto the image data to be processed, wherein a projection area of the reference image on the image data to be processed covers a pixel to be matched and verified;
weighting pixel values in a first pixel set within the projection area to obtain a first pixel weighted value, wherein the first pixel set is a set of pixels that match positions of a first pixel value in the reference image;
weighting pixel values in a second pixel set within the projection area to obtain a second pixel weighted value, wherein the second pixel set is a set of pixels that match positions of a second pixel value in the reference image; and
determining whether the pixel to be matched and verified is an edge pixel based on the first pixel weighted value and the second pixel weighted value.

6. The method according to claim 5, wherein:
weighting the pixel values in the first pixel set within the projection area to obtain the first pixel weighted value includes: weighting a first preset value and the pixel values in the first pixel set within the projection area to obtain the first pixel weighted value; and/or
weighting the pixel values in the second pixel set within the projection area to obtain the second pixel weighted value includes: weighting a second preset value and the pixel values in the second pixel set within the projection area to obtain the second pixel weighted value.

7. The method according to claim 5, wherein:
the pixel to be matched and verified is located at a center of the projection area.

8. The method according to claim 5, wherein determining whether the pixel to be matched and verified is an edge pixel based on the first pixel weighted value and the second pixel weighted value incudes:
weighting the pixel value of each pixel in the projection area to obtain a third pixel weighted value; and
determining whether the pixel to be matched and verified is an edge pixel based on the first pixel weighted value, the second pixel weighted value, and the third pixel weighted value.

9. The method according to claim 8, wherein:
The first pixel value is 1 and the second pixel value is 0; and
determining whether the pixel to be matched and verified is an edge pixel based on the first pixel weighted value, the second pixel weighted value, and the third pixel weighted value includes:
when the first pixel weighted value is less than the second pixel weighted value and the third pixel weighted value is larger than or equal to a third preset value, determining that the pixel to be matched and verified is an edge pixel.

10. The method according to claim 4, wherein:
performing the matching verification on each pixel in the image data to be processed to obtain a matching verification result for each pixel by taking each reference image as sliding windows includes: using the multiple reference images as sliding windows to perform the matching verification on each pixel in the image data to be processed to obtain multiple matching verification results corresponding to each pixel; and
when the matching verification result of one pixel in the image data to be processed meets the preset edge feature condition, determining that the pixel is an edge pixel includes: when any matching verification result of the pixel in the image data to be processed meets the preset edge feature condition, determining that the pixel is an edge pixel; wherein the edge angles corresponding to the multiple reference images are different.

11. The method according to claim 3, wherein taking the edge pixels as the centers to smooth pixel values of the pixels within the preset range to obtain the processed image data includes:
taking each edge pixel as one center, respectively calculating a pixel weighted average value of each adjacent pixel of the edge pixel and the edge pixel; and
rounding the pixel weighted average value to an integer and assigning it to the corresponding adjacent pixel to obtain the processed image data.

12. The method according to claim 3, wherein taking the edge pixels as the centers to smooth pixel values of pixels within the preset range to obtain the processed image data includes:
taking each edge pixel as one center, respectively calculating a pixel weighted average value of each aliasing pixel in adjacent pixels of the edge pixel and the edge pixel; and
rounding the pixel weighted average value to an integer and assigning it to the corresponding aliasing pixel to obtain the processed image data.

13. The method according to claim 1, before smoothing the edge pixels to obtain the processed image data, further including:
determining whether the image data to be processed is 1-bit halftone image data or multi-bit halftone image data; and
when the image data to be processed is 1-bit halftone image data, converting the image data to be processed into multi-bit halftone image data, wherein a pixel value of each pixel in the 1-bit halftone image data is 1-bit data and a pixel value of each pixel in the multi-bit halftone image data is data with more than 1-bit data.

14. The method according to claim 1, wherein:
smoothing the edge pixels includes smoothing the edge pixels only.

15. An imaging forming device, comprising:
a controller, configured to perform:
obtaining image data to be processed, wherein the image data to be processed is halftone image data;
performing edge detection on the image data to be processed to determine edge pixels in the image data to be processed; and
smoothing the edge pixels to obtain processed image data.

16. A non-transitory computer-readable storage medium, wherein:
the computer-readable storage medium is configured to store a program; and
when the program is running, a device where the computer-readable storage medium is located is configured to perform:
in response to a first mode triggered by a user, performing an image forming operation on image data to be processed; or
in response to a second mode triggered by a user, processing the image data to be processed to obtain processed image data; and performing an image forming operation on the processed image data,
wherein processing the image data to be processed to obtain the processed image data includes:
obtaining image data to be processed, wherein the image data to be processed is halftone image data;
performing edge detection on the image data to be processed to determine edge pixels in the image data to be processed; and
smoothing the edge pixels to obtain processed image data.

17. The storage medium according to claim 16, wherein:
performing the edge detection on the image data to be processed to determine the edge pixels in the image data to be processed includes: performing the edge detection on the image data to be processed through reference images to determine the edge pixels in the image data to be processed, wherein one reference image is an image with edge features;
performing the edge detection on the image data to be processed through the reference images to determine the edge pixels in the image data to be processed includes: taking each reference image as sliding windows, performing matching verification on each pixel in the image data to be processed to obtain a matching verification result for each pixel; and when the matching verification result of one pixel in the image data to be processed meets a preset edge feature condition, determining the pixel to be an edge pixel; and
the matching verification includes:
projecting the reference image onto the image data to be processed, wherein a projection area of the reference image on the image data to be processed covers a pixel to be matched and verified;
weighting pixel values in a first pixel set within the projection area to obtain a first pixel weighted value, wherein the first pixel set is a set of pixels that match positions of a first pixel value in the reference image;
weighting pixel values in a second pixel set within the projection area to obtain a second pixel weighted value, wherein the second pixel set is a set of pixels that match positions of a second pixel value in the reference image; and
determining whether the pixel to be matched and verified is an edge pixel based on the first pixel weighted value and the second pixel weighted value.

18. The storage medium according to claim 17, wherein, determining whether the pixel to be matched and verified is an edge pixel based on the first pixel weighted value and the second pixel weighted value incudes:
weighting the pixel value of each pixel in the projection area to obtain a third pixel weighted value; and determining whether the pixel to be matched and verified is an edge pixel based on the first pixel weighted value, the second pixel weighted value, and the third pixel weighted value.

19. The storage medium according to claim 16, wherein:
before smoothing the edge pixels to obtain the processed image data, further including: determining whether the image data to be processed is 1-bit halftone image data or multi-bit halftone image data; and
when the image data to be processed is 1-bit halftone image data, converting the image data to be processed into multi-bit halftone image data, wherein a pixel value of each pixel in the 1-bit halftone image data is 1-bit data and a pixel value of each pixel in the multi-bit halftone image data is data with more than 1-bit data.

20. The storage medium according to claim 16, wherein:
the device where the computer-readable storage medium is located is further configured to perform displaying effect diagram of the processed image data in a display interface.
